(19) United States
(12) Patent Application Publication
(10) Pub. No.: US 2014/0313520 A1
(43) Pub. Date: Oct. 23, 2014

(54) LOCATION DETERMINATION USING LIGHT SOURCES

(71) Applicants: Lutz Naethke, Braunschweig (DE); Andrey Nikolaev, Novgorod (RU); Avishay Sharaga, Bet Nehemya (IL); Zdravko Boos, Munich (DE); Wing Yan Mok, Munich (DE)

(72) Inventors: Lutz Naethke, Braunschweig (DE); Andrey Nikolaev, Novgorod (RU); Avishay Sharaga, Bet Nehemya (IL); Zdravko Boos, Munich (DE); Wing Yan Mok, Munich (DE)

(21) Appl. No.: 13/866,178

(22) Filed: Apr. 19, 2013

(51) Int. Cl. G01B 11/14

(52) U.S. Cl. CPC G01B 11/14
USPC 356/614

(57) ABSTRACT

The present disclosure relates to computer-implemented systems and methods for location determination using light sources. An example method may include receiving, by a computer including one or more processors, a location request for a device within an indoor environment. The method may also include receiving respective light source identifiers associated with one or more light sources in the indoor environment. The one or more light sources may be in communication with the device. Additionally, the method may include accessing, by the computer, a virtual map associated with the indoor environment, and the virtual map may include one or more associations between the respective light source identifiers and respective positions, within the indoor environment, of the one or more light sources. Furthermore, the method may include determining, based at least in part on the virtual map and the respective light source identifiers, a location of the device within the indoor environment.

### TECHNICAL FIELD

The present disclosure generally relates to location estimation, and in particular, to location determination using light sources.

### BACKGROUND

Recently, deriving and/or estimating indoor location information has grown increasingly important. One conventional method of estimating the indoor location associated with a device may be to employ specialized hardware such as Bluetooth low energy, ultra-wide band, and/or the like. Other conventional methods may involve generating a wireless signal map from various clusters of wireless access points. On the other hand, the cost of deployment and/or the estimation accuracy of certain conventional methods may still serve as hindrances.

### BRIEF DESCRIPTION OF THE DRAWINGS

Reference will now be made to the accompanying figures and diagrams, which are not necessarily drawn to scale, and wherein:

FIG. 1 shows a block diagram of a system for location determination using light sources, according to one or more example embodiments.

FIG. 2 shows another block diagram of a system for location determination using light sources, according to one or more example embodiments.

FIG. 3A shows a diagram of an indoor environment, according to one or more example embodiments.

FIG. 3B shows a user path within an indoor environment, according to one or more example embodiments.

FIG. 4 shows a flow diagram for location determination using light sources, according to one or more example embodiments.

### DETAILED DESCRIPTION

In the following description, numerous specific details are set forth. However, it should be understood that embodiments of the present disclosure may be practiced without these specific details. In other instances, well-known methods, structures, and techniques have not been shown in detail in order not to obscure an understanding of this description. References to “one embodiment,” “an embodiment,” “example embodiment,” “various embodiments,” and so forth indicate that the embodiment(s) of the present disclosure so described may include a particular feature, structure, or characteristic, but not every embodiment necessarily includes the particular feature, structure, or characteristic. Furthermore, repeated use of the phrase “in one embodiment” does not necessarily refer to the same embodiment, although it may.

As used herein, unless otherwise specified, the use of the ordinal adjectives “first,” “second,” “third,” etc., to describe a common object merely indicates that different instances of like objects are being referred to and are not intended to imply that the objects so described must be in a given sequence, either temporally, spatially, in ranking, or in any other manner.

As used herein, unless otherwise specified, the term “mobile device” refers, in general, to a wireless communication device, and more particularly to one or more of the following: a portable electronic device, a telephone (e.g., cellular phone, smart phone), a computer (e.g., laptop computer, tablet computer), a portable media player, a personal digital assistant (PDA), or any other electronic device having a networked capability.

As used herein, unless otherwise specified, the term “server” may refer to any computing device having a networked connectivity and configured to provide one or more dedicated services to clients, such as a mobile device. The services may include storage of data or any kind of data processing. One example of the server may include a web server hosting one or more web pages. Some examples of web pages may include social networking web pages. Another example of a server may be a cloud server that hosts web services for one or more computer devices.

As used herein, unless otherwise specified, the term “receiver” may refer to any device or component capable of receiving data, signals, information, etc. For example, a receiver may include an antenna or any other receiving device.

As used herein, unless otherwise specified, the term “transmitter” may refer to any device or component capable of transmitting data, signals, information, etc. For example, a transmitter may also include an antenna or any other transmission device.

The present disclosure relates to computer-implemented systems and methods for location estimation using a mobile device. According to one or more embodiments of the disclosure, a method is provided. The method may include receiving, by a computer including one or more processors, a location request for a device within an indoor environment. The method may also include receiving respective light source identifiers associated with one or more light sources in the indoor environment. The one or more light sources may be in communication with the device. Additionally, the method may include accessing, by the computer, a virtual map associated with the indoor environment, and the virtual map may include one or more associations between the respective light source identifiers and the respective positions, within the indoor environment, of the one or more light sources. Furthermore, the method may include determining, based at least in part on the virtual map and the respective light source identifiers, a location of the device within the indoor environment.

According to one or more embodiments of the disclosure, a device is provided. The device may include at least one memory for storing data and computer-executable instructions. Additionally, the device may also include at least one processor to access the at least one memory and to execute the computer-executable instructions. Furthermore, the at least one processor may be configured to execute the instructions to access a virtual map associated with an indoor environment. The virtual map may indicate respective positions of one or more light sources in the indoor environment according to respective light source identifiers associated with the one or more light sources. Additionally, the at least one processor may be configured to execute the instructions to receive at least one light source identifier associated with the one or more light sources and determine, based at least in part on the at least one light source identifier and the virtual map, a location of the device within the indoor environment.

According to one or more embodiments of the disclosure, a non-transitory computer-readable medium is provided. The non-transitory computer-readable medium may have embodied thereon instructions executable by one or more processors. The instructions may cause the one or more processors to receive, at a device, one or more signature measurements associated with an indoor environment. As such, the device may be associated with a user. Additionally, the computer-readable medium may include instructions to receive a location request for a device within an indoor environment. Moreover, the computer-readable medium may include instructions to receive respective light source identifiers associated with one or more light sources in the indoor environment. To this end, the one or more light sources may be in communication with the device. In addition, the medium may include instructions to access a virtual map associated with the indoor environment, the virtual map including one or more associations between the respective light source identifiers and the respective positions, within the indoor environment, of the one or more light sources. The computer-readable medium may include further instructions to determine, based at least in part on the at least one light source identifier and the virtual map, a location of the device within the indoor environment.

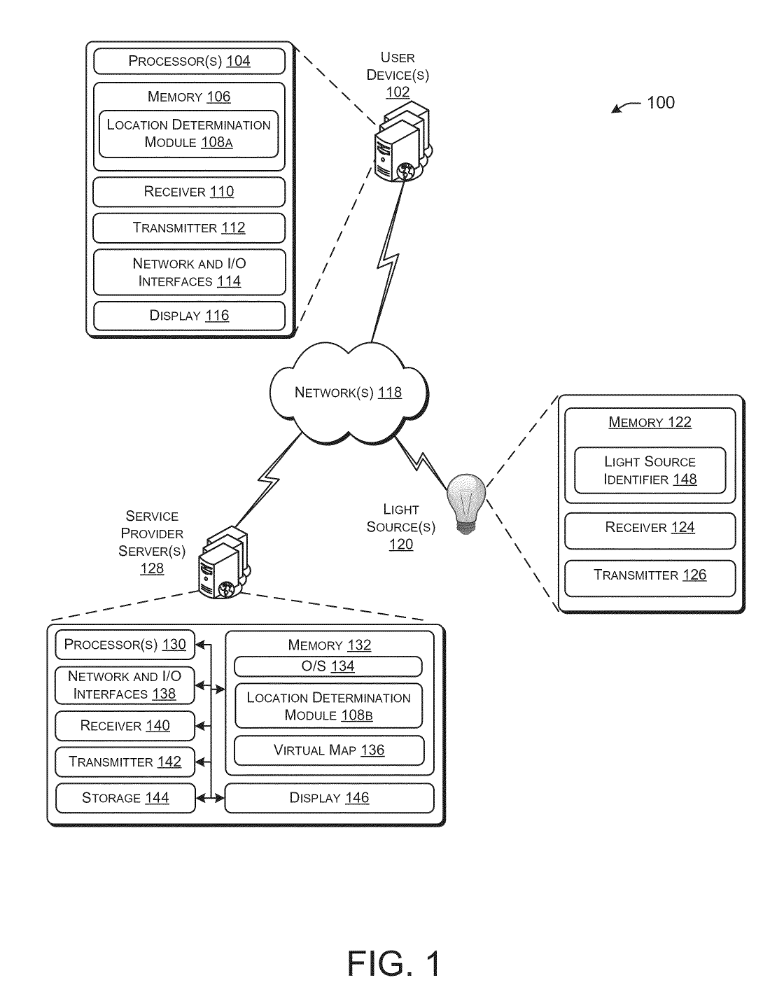

The above principles, as well as perhaps others, are now illustrated with reference to FIG. 1, which depicts a system 100 for location determination using light sources. The system 100 may include a user device 102 having one or more computer processors 104, a memory 106, which may store a location determination module 108A, a receiver 110, a transmitter 112, network and input/output (I/O) interfaces 114, and a display 116 in communication with each other.

The computer processors 104 may comprise one or more cores and may be configured to access and execute (at least in part) computer-readable instructions stored in the memory 106. The one or more computer processors 104 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The user device 102 may also include a chipset (not shown) for controlling communications between the one or more processors 104 and one or more of the other components of the user device 102. In certain embodiments, the user device 102 may be based on an Intel® architecture or an ARM® architecture, and the processor(s) and chipset may be from a family of Intel® processors and chipsets. The one or more processors 104 may also include one or more application-specific integrated circuits (ASICs) or application-specific standard products (ASSPs) for handling specific data processing functions or tasks.

The memory 106 may comprise one or more computer-readable storage media (CRSM). In some embodiments, the memory 106 may include non-transitory media such as random access memory (RAM), flash RAM, magnetic media, optical media, solid-state media, and so forth. The memory 106 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory 106 may store an operating system that includes a plurality of computer-executable instructions that may be implemented by the computer processor 104 to perform a variety of tasks to operate the interface(s) and any other hardware installed on the user device 102. The memory 106 may also store content that may be displayed by the user device 102 or transferred to other devices (e.g., headphones) to be displayed or played by the other devices. The memory 106 may also store content received from the other devices. The content from the other devices may be displayed, played, or used by the user device 102 to perform any necessary tasks or operations that may be implemented by the computer processor 104 or other components in the user device 102.

The network and I/O interfaces 114 may also comprise one or more communication interfaces or network interface devices to provide for the transfer of data between the user device 102 and another device (e.g., network server) via a network (not shown). The communication interfaces may include, but are not limited to: personal area networks (PANs), wired local area networks (LANs), wireless local area networks (WLANs), wireless wide area networks (WWANs), and so forth. The user device 102 may be coupled to the network via a wired connection. However, the wireless system interfaces may include the hardware and software to broadcast and receive messages either using the Wi-Fi Direct Standard (see Wi-Fi Direct specification published in October 2010) and/or the IEEE 802.11 wireless standard (see IEEE 802.11-2007, published Mar. 8, 2007; IEEE 802.11n-2009, published October 2009), or a combination thereof. The wireless system (not shown) may include a transmitter and a receiver or a transceiver (not shown) capable of operating in a broad range of operating frequencies governed by the IEEE 802.11 wireless standards. The communication interfaces may utilize acoustic, radio frequency, optical, or other signals to exchange data between the user device 102 and another device such as an access point, a host computer, a server, a router, a reader device, and the like. The network may include, but is not limited to: the Internet, a private network, a virtual private network, a wireless wide area network, a local area network, a metropolitan area network, a telephone network, and so forth.

The display 116 may include, but is not limited to, a liquid crystal display, a light-emitting diode display, or an E-Ink™ display as made by E Ink Corp. of Cambridge, Mass. The display may be used to show content to a user in the form of text, images, or video. In certain instances, the display may also operate as a touch screen display that may enable the user to initiate commands or operations by touching the screen using certain finger or hand gestures.

The system 100 may also include one or more light sources 120 and one or more service provider servers 128. To this end, the user device 102, the light source(s) 120, and the service provider server(s) 128 may be in communication with each other through one or more networks 118.

The light source(s) 120 may include a memory 122, a receiver 124, and a transmitter 126. The light source(s) 120 may include any component capable of generating or transmitting light, such as a light bulb, a light bulb socket, light emitting diodes, and/or the like. Additionally, the memory 122, receiver 124, and the transmitter 126 may be included as part of the light source(s) 120, or alternatively, may be included as part of a separate device that may be transfixed or otherwise attached to the light source(s) 120. According to some embodiments, the memory 122 of a light source 120 may store a respective light source identifier 148 that may be transmitted (e.g., via the transmitter 126) to one or more components of the system 100. In certain implementations, the light source identifiers 148 may be dynamically assigned to respective light sources 120 by the service provider servers 128. Alternatively, the light source identifiers 148 may be permanently fixed to respective light sources 120, similar to how media access control (MAC) addresses may be permanently fixed to network devices.

In addition, the receivers 110, 124, 140 and the transmitters 112, 126, 142 may be configured to receiver and transmit signals according to various communication interfaces. Such communication interfaces may include a wireless local area network (WLAN), Bluetooth, a radio, and/or any other wireless communication interfaces. In some embodiments, the light source 120 may communicate through the modulation of different forms of visible and invisible light (e.g., infrared and/or ultraviolet light). For example, the light source 120 and/or the transmitter 126 of the light source 120 may be configured to generate light associated with certain color temperatures and/or brightness intensity. To this end, different color temperatures, brightness intensities, and/or any combinations thereof may be used to indicate or otherwise represent respective light source identifiers 148. In other examples, the light source 120 may also be configured to modulate other types of signals (e.g., ultrasonic sound) to communicate respective light source identifiers 148.

The service provider server(s) 128 may include one or more processors 130 to execute instructions stored in a memory 132. The memory 132 may include an operating system (O/S) 134, a location determination module 108B, and a virtual map 136. The service provider server(s) 128 may further include network and I/O interfaces 138, a receiver 140, a transmitter 142, storage 144, and a display 146.

Broadly, the user device(s) 102, light source(s) 120, and the service provider server(s) 128 may communicate with each other to determine the location of the user device(s) 102 within an indoor environment (e.g., a room, a house, a building, etc.). In certain implementations, each light source 120 may be associated with a light source identifier 148. Furthermore, a virtual/digital map 136, which may be stored in the service provider server(s) 128, user device 102, and/or any other component, may be a map of the indoor environment that indicates respective locations of the light source(s) 120 within the indoor environment. For example, the virtual map 136 may store one or more associations between the light source identifiers 148 and the respective locations of the light source(s) 120 associated with the light source identifiers 148. Thus, based on the virtual map 136 and the one or more light source identifiers 148, a location of the user device(s) 102 within the indoor environment may be determined. Thus, a user device 102 within the indoor environment may communicate with the light source(s) 120, service provider server(s) 128, and/or a combination thereof to access and/or otherwise retrieve the virtual map 136 and the one or more light source identifiers 148.

In some embodiments, the virtual map 136 may be configured to represent the indoor environment as one or more grid coordinates. In other embodiments, the virtual map 136 may be a digital representation of the indoor environment according to one or more rooms in the indoor environment. For instance, the virtual map 136 may include a database that stores respective associations between light source identifiers 148 and grid coordinates/rooms. To this end, the database may be implemented using any database management system including, but not limited to, MySQL, PostgreSQL, SQLite, Microsoft SQL Server, Microsoft Access, Oracle Sybase, dBASE, FoxPro, IBM DB2, and/or the like. According to yet other embodiments, the virtual map 136 may further be associated with various floor plans, blueprints, computer-aided designs, and/or any other type of technical drawings related to the indoor environment.

For example, consider a scenario in which a user device 102 may desire to determine its location within an indoor environment. To this end, the location determination module 108A in the user device 102 may communicate with one or more service provider servers 128 and/or light sources 120 in the indoor environment. Such communication may include a request for location determination. In response, the user device 102 may receive respective light source identifiers 148 associated with any light sources 120 in communication with the user device 102. The user device 102 may then access the virtual map 136 (e.g., the user device 102 may download the virtual map 136 or a portion thereof from the service provider server(s) 128, or the user device 102 may simply provide the light source identifiers 148 to the service provider server(s) 128 to access location information from the virtual map 136). As such, the location determination module 108A may be configured to determine, based at least in part on the virtual map 136 and the respective light source identifiers 148, a location of the user device 102 with respect to the indoor environment. The location estimation module 108A may then be configured to communicate with the display 116 to display the location of the user device 102 on the user device 102.

In other embodiments, the location determination of the user device 102 may be performed by the location determination module 108B in the service provider server(s) 128. For example, the user device 102 may provide the respective light source identifiers 148 to the service provider server(s) 128. Then, based at least in part on the respective light source identifiers 148 and the virtual map 136, the location determination module 108B may determine a location of the user device 102 within the indoor environment.

It should be understood that any other distribution of the location determination process, among the system 100 components, is also contemplated within the present disclosure. For example, according to certain embodiments, once the user device 102 has communicated a location determination request to the light source(s) 120, the light source(s) 120 may be configured to transmit (e.g., via the transmitter) the request and respective light source identifiers 148 to the service provider server(s) 128. The location determination module 108B of the service provider server(s) 128 may then determine, based at least in part on the virtual map 136 and the respective light source identifiers 148, a location for the user device 102 within the indoor environment. To this end, the location determination may be transmitted back to one or more of the light source(s) 120, which may in turn forward the location determination to the user device 102.

In other implementations, the light source(s) 120 may be configured to periodically broadcast signals indicating respective light source identifiers 148. When a user device 102 desires location determination, the location determination module 108A may be configured to receive such broadcasted signals, and thereby receive and/or identify one or more light source identifiers 148. The location determination module 108A may then be configured to access the virtual map 136 to determine, based at least in part on the virtual map 136 and the light source identifiers 148, a location of the user device 102 with respect to the indoor environment.

In certain embodiments, the location of the user device 102 may be determined according to the nearest light source 120 to the user device 102. For example, the location determination module 108A may communicate with one or more light sources 120, and determine, based on certain signal characteristics of such communication, which light source 120 is nearest to the user device 102. As such, the light source identifier 148 associated with the nearest light source 120 and the virtual map 136 may be used (e.g., by the location determination modules 108A-108B) to determine the location of the user device 102 within the indoor environment.

In other embodiments, the location of the user device 102 may be determined according to an interpolation of data received from multiple light sources 120. Furthermore, the interpolation technique may provide a more precise determination of the location of the user device 102 compared to using the nearest light source 120 as a basis for location determination. For instance, the location determination module 108A may communicate with multiple light sources 120 to identify their respective light source identifiers 148. Using the light source identifiers 148, the location determination module 108A may then access the virtual map 136 to determine respective locations of the multiple light sources 120 associated with the light source identifiers 148. Additionally, the location determination module 108A may be configured to analyze certain signal characteristics of the above-mentioned communications between the user device 102 and the multiple light sources 120. For example, such analysis may include determining respective distances between the user device 102 and the multiple light sources 120. Moreover, based on this analysis, the location determination module 108A may be operable to interpolate the respective distances (between the user device 102 and the multiple light sources 120) to determine the location of the user device 102 within the indoor environment.

In other implementations, and as mentioned above, the light source(s) 120 may be configured to modulate light and/or other types of signals in order to communicate respective light source identifiers 148. In such embodiments, the light source(s) 120 may not be equipped with any storage capacity or processing capability. Furthermore, the user device 102 may include one or more sensors to receive and/or identify light source identifiers 148 transmitted by the light source(s) 120. For instance, the user device 102 may include a camera to identify certain characteristics associated with the light generated by the light source(s) 120. As previously described, such characteristics may include varying color temperature and/or brightness intensity of the light. Based on such characteristics, the user device 102 may determine (e.g., via the camera, the location determination module 108A, and/or a combination thereof) respective light source identifiers 148 associated with the light source(s) 120. As such, the location determination module 108A may then be configured to access the virtual map 136 and determine, based at least in part on the virtual map 136 and the respective light source identifiers 148, a location of the user device 102 with respect to the indoor environment.

According to one or more embodiments, the virtual map 136 may be updated to account for one or more failures of the light source(s) 120. For example, a failure may occur when a light source 120 is no longer able to generate light. To this end, a user device 102, the service provider servers 128, the light sources 120, and/or any combination thereof may be configured to detect a failure of a light source 120 and to identify the associated light source identifier 148 of the failed light source 120. Once the failure has been detected, the virtual map 136 may be updated to indicate the failure associated with the light source identifier 148.

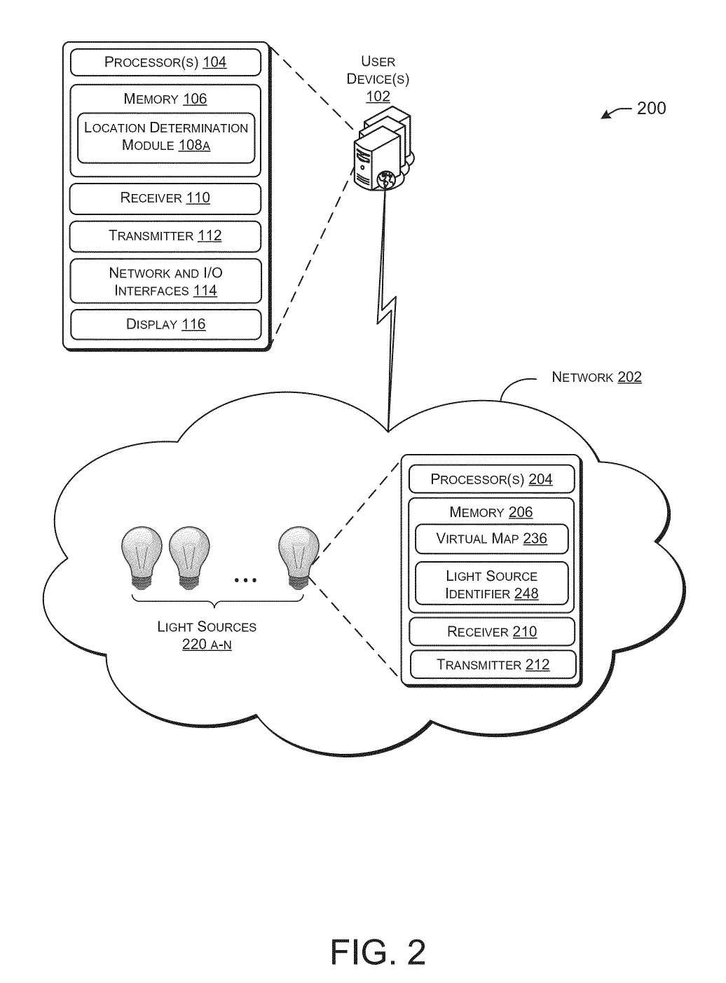

Moreover, according to certain embodiments, the location of the user device 102, within the indoor environment, may be determined without the one or more service provider server(s) 128. To this end, FIG. 2 illustrates a system 200 for location determination using light sources, without a central server, according to one or more embodiments of the present disclosure. The system 200 may include the user device(s) 102, as illustrated with respect to FIG. 1. Additionally, the system may include a network 202 of light sources 220A-N in communication with the user device(s) 102. For example, the network 202 may be an ad-hoc network of light sources 220A-N and/or any other type of network.

The light sources 220A-N may include one or more processors 204, a memory 206, a receiver 210, and a transmitter 212. Furthermore, the memory 206 may include a virtual map 236. In some implementations, the entire virtual map 236 may be stored in each light source 220A-N. Alternatively, the virtual map 236 may be distributed among the light sources 220A-N with each light source 220A-N storing only a portion of the virtual map 236. Thus, the user device 102 may communicate with one or more light sources 220A-N in the network 202 and receive respective light source identifiers 248 from the one or more light sources 220A-N. Additionally, the location determination module 108A of the user device 102 may also access the virtual map 236 and determine, based on the virtual map 236 and the light source identifiers 248, a location of the user device 102 within the indoor environment.

According to other embodiments, the light sources 220A-N may also be capable of performing location determination, either individually or collectively, for the user device 102. For example, one or more of the light sources 220A-N may receive a request for location determination from the user device 102. As such, the one or more light sources 220A-N may be capable of determining, based at least in part on their respective light source identifiers 248 and the virtual map 236, a location of the user device 102 within the indoor environment.

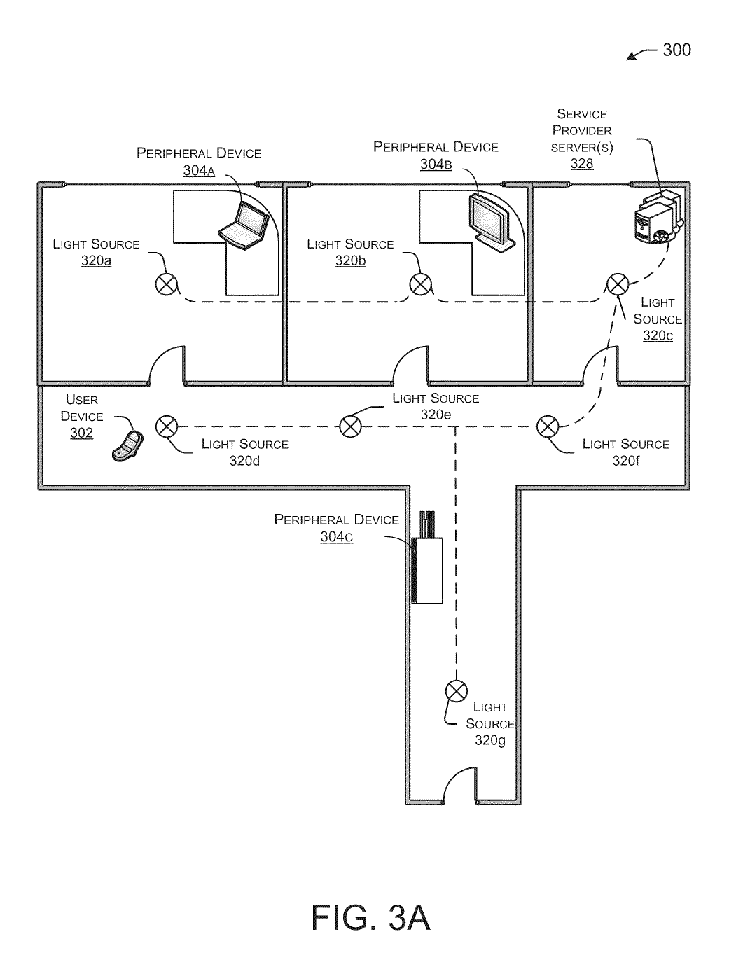

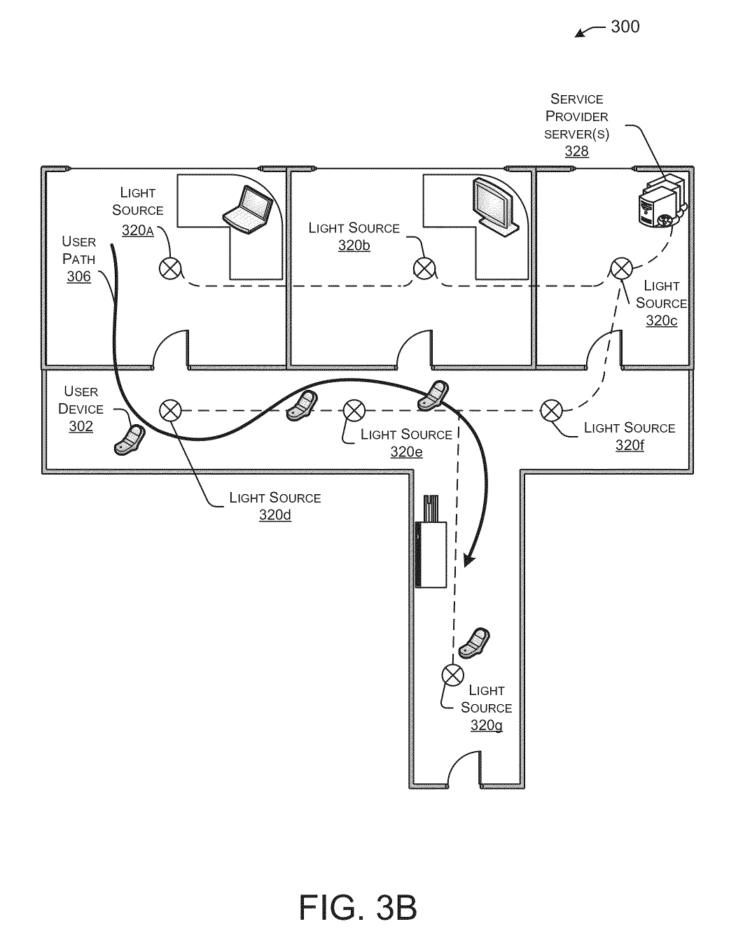

FIG. 3A illustrates a diagram of an indoor environment 300 according to one or more embodiments of the present disclosure. The indoor environment 300 may be divided into several rooms and may include various peripheral devices 304a-c. Furthermore, the indoor environment 300 may include one or more light sources 320a-g in communication with one or more service provider servers 328. Though not illustrated, a virtual map of the indoor environment 300 may be stored on one or more of the user devices 302, the light sources 320a-g, or the service provider server(s) 328. The virtual map may store associations between light source identifiers associated with the light sources 320a-g and the respective locations of the light sources 320a-g within the indoor environment 300. To this end, the service provider server(s) 328, the light sources 320a-g, and/or a combination thereof may be configured to determine a location of a user device 302 within the indoor environment 300 according to the various techniques and frameworks described above.

Additionally, in some embodiments, the light sources 320a-g, the service provider servers 328 and/or a combination thereof may be capable of determining the location of the peripheral devices 304a-c within the indoor environment 300. Such location determination may include determining whether the peripheral devices 304a-c have remained in a designated area. For example, a peripheral device 304a may include one or more respective transmitters capable of periodically transmitting signals to the light source 320a. Furthermore, the peripheral device 304a may be associated with a restriction to remain within a set distance from the light source 320a, such as within the room. Based on these transmitted signals, the light sources 320a-g and/or the service provider servers 328 may be configured to determine the distance of the peripheral device 304a from the light source 320a. If the peripheral device 304a travels outside the restricted distance from the light source 320a, the light source 320a may transmit a notification of the violation to the service provider server 328 and/or any other device. In some embodiments, if the peripheral device 320a travels outside its designated boundary, the service provider server 328 may be configured to transmit a signal to shut down the peripheral device 304a.

It should be noted that the indoor environment 300 is not restricted to the particular layout and components illustrated in FIG. 3A, and that various other layouts and components associated with the indoor environment 300 are also contemplated within the present disclosure.

Turning now to FIG. 3B, an example user path 306 within the indoor environment 300 may be illustrated according to one or more embodiments of the present disclosure. As depicted in FIG. 3B, the user path 306 may begin near light source 320a, proceed successively through near light source 320d, light source 320e, and light source 320g.

As previously discussed, the location of the user device 302 within the indoor environment 300 may be determined according to various techniques. One such technique may include determining the location of the user device 302 according to the location of the nearest light source 320a-g. To this end, as the user device 302 begins to travel along the user path 306, the location of the user device 302 may initially be determined to be the location of light source 320a. As the user device 302 travels near light source 320d, the determined location of the user device 302 may remain the same as the location of light source 320a until the user device 302 is nearer to light source 320d than to light source 320a. Once the user device 302 is nearer to light source 320d than to light source 320a, the location of the user device 302 may be determined to be the same location as light source 320d.

Alternatively, the location of the user device 302 may be determined by interpolating the location of the user device 302 with respect to respective locations of one or more of the light sources 320a-g. Thus, the location of the user device 302 may not be restricted to the discrete locations of the light sources 320a-g, as is the case with the previously described nearest-light-source approach. Instead, interpolating the location of the user device 302 with respect to locations of multiple light sources 320a-g may provide a relatively more precise location determination.

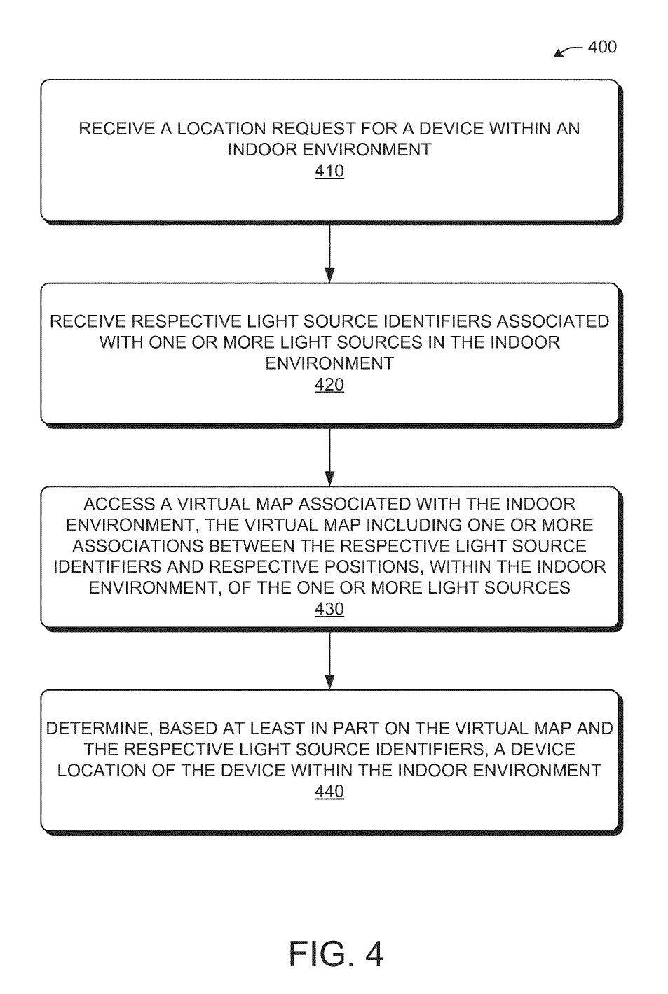

FIG. 4 illustrates a flow diagram of a method 400 for location determination using light sources according to one or more embodiments of the present disclosure. According to block 410 of the method, a service provider server 128 may receive a location request for user device 302 within an indoor environment. For example, the service provider server 128 may receive the request directly, or the request may be forwarded to the service provider server 128 by one or more light sources 120 in the indoor environment.

In block 420, the service provider server 128 may receive respective light source identifiers 148 associated with one or more light sources 120 in the indoor environment. As discussed above, the light source identifiers 148 may be stored with respective light sources 120. Alternatively, the light sources 120 may be configured to transmit and/or modulate signals with certain characteristics that may be used to identify respective light sources 120. Additionally, the service provider server 128 may receive the light source identifiers 148 from the light sources 120, the user device 102, or any other device or combination of devices.

In block 430, the service provider server 128 may be configured to access a virtual map 136 associated with the indoor environment. As such, the virtual map 136 may include one or more associations between the respective light source identifiers 148 and respective positions, within the indoor environment of the one or more light sources 120. In block 440, the service provider server 128 may determine, based at least in part on the virtual map 136 and the respective light source identifiers 148, a device location of the user device 302 within the indoor environment.

While the foregoing description of the method 400 of FIG. 4 has been described from the perspective of the service provider server 128, it should noted that the method 400 may also be performed by the user device 102. For example, the roles of the service provider servers 128 and the user device 102 with respect to the method 400 may be reversed.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the present disclosure have been described in connection with what is presently considered to be the most practical and various embodiments, it is to be understood that the present disclosure is not to be limited to the disclosed embodiments, but is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### EXAMPLES

Example 1 is a method for determining location, comprising receiving, by a computer comprising one or more processors, a location request for a device within an indoor environment; receiving respective light source identifiers associated with one or more light sources in the indoor environment, the one or more light sources in communication with the device; accessing, by the computer, a virtual map associated with the indoor environment, the virtual map comprising one or more associations between the respective light source identifiers and respective positions, within the indoor environment, of the one or more light sources; and determining, based at least in part on the virtual map and respective light source identifiers, a location of the device within the indoor environment.

In Example 2, the subject matter of Example 1 can optionally include that the at least one of the one or more light sources comprises a nearest light source to the device.

In Example 3, the subject matter of Example 1 can optionally include that determining the device location further comprises interpolating respective positions of the one or more light sources with respect to the device.

In Example 4, the subject matter of Example 1 can optionally include that the light source comprises at least one of a light bulb or a light bulb socket.

In Example 5, the subject matter of Example 1 or 3 can optionally include transmitting the virtual map to the one or more light sources.

In Example 6, the subject matter of Example 5 can optionally include updating the virtual map in response to a failure associated with at least one of the one or more light sources

In Example 7, the subject matter of Example 1 or 4 can optionally include determining, based on the device location, the device is not within a location boundary; and generating, by the computer, a notification indicating the device is not within the location boundary.

In Example 8, the subject matter of Example 7 can optionally include transmitting, by the computer, a signal to shut down the device.

In Example 9, the subject matter of Example 1 or 4 can optionally include transmitting the location to the device.

Example 10 is a device for determining location, comprising: at least one processor; and at least one memory storing computer-executable instructions, that when executed by the at least one processor, causes the at least one processor to: access a virtual map associated with an indoor environment, wherein the virtual map indicates respective positions of one or more light sources in the indoor environment according to respective light source identifiers associated with the one or more light sources; receive at least one light source identifier associated with the one or more light sources; and determine, based at least in part on the at least one light source identifier and the virtual map, a location of the device within the indoor environment.

In Example 11, the subject matter of Example 10 can optionally include that the one or more light sources comprises one or more light bulbs or one or more light bulb sockets.

In Example 12, the subject matter of Example 10 or 11 can optionally include that the at least one identifier is associated with a respective light source, of the one or more light sources, that is nearest to the device.

In Example 13, the subject matter of Example 10 or 11 can optionally include that the at least one light source identifier comprises a plurality of light source identifiers associated with respective light sources, and that the location of the device is determined based at least in part on the virtual map, the plurality of light source identifiers, and an interpolation of respective positions of the respective light sources according to the virtual map and the plurality of light source identifiers.

In Example 14, the subject matter of Example 10 or 11 can optionally include that the computer-executable instructions further cause the at least one processor to determine, based on the virtual map and the at least one light source identifier, a failed light source of the one or more light sources.

In Example 15, the subject matter of Example 14 can optionally include that the computer-executable instructions further cause the at least one processor to generate an update to the virtual map to account for the failed light source.

In Example 16, the subject matter of Example 10 or 11 can optionally include that the computer-executable instructions further cause the at least one processor to display the location of the device within the indoor environment.

In Example 17 is an apparatus for determining location, comprising: a light source for generating light; a receiver, coupled to the light source, to receive a device identification associated with a device in an indoor environment and access a digital map associated with an indoor environment; a location estimation module to determine, based at least in part on the device identification and the digital map, a location of the device within the indoor environment; and a transmitter to transmit the location of the device to a server or to the device.

In Example 18, the subject matter of Example 17 can optionally include that the light source comprises at least one of a light bulb or light bulb socket.

In Example 19, the subject matter of Example 17 or 18 can optionally include transmitting, by the transmitter, a location of the light source to the location estimation module.

In Example 20, the subject matter of Example 17 or 18 can optionally include transmitting, by the transmitter a light source identification to the location estimation module.

In Example 21 is an apparatus for determining location, comprising: means for receiving a location request for a device that is within an indoor environment; means for receiving respective light source identifiers associated with one or more light sources in the indoor environment, the one or more light sources in communication with the device; means for accessing a virtual map associated with the indoor environment, the virtual map including one or more associations between the respective light source identifiers and respective positions, within the indoor environment, of the one or more light sources; and means for determining, based at least in part on the virtual map and respective light source identifiers, a device location of the device within the indoor environment.

In Example 22, the subject matter of Example 21 can optionally include that the at least one of the one or more light sources comprises a nearest light source to the device.

In Example 23, the subject matter of Example 21 can optionally include that the means for determining the device location further comprises means for interpolating respective positions of the one or more light sources with respect to the device.

In Example 24, the subject matter of Example 21 can optionally include that the light source comprises at least one of a light bulb or a light bulb socket.

In Example 25, the subject matter of Example 22 or 23 can optionally include means for transmitting the virtual map to the one or more light sources.

In Example 26, the subject matter of Example 25 can optionally include means for updating the virtual map in response to a failure associated with at least one of the one or more light sources.

In Example 27, the subject matter of Example 21 or 24 can optionally include means for determining, based on the device location, the device is not within a location boundary; and means for generating a notification indicating the device is not within the location boundary.

In Example 28, the subject matter of Example 27 can optionally include means for transmitting a signal to shut down the device.

In Example 29, the subject matter of Example 21 or 24 can optionally include means for transmitting the location to the device.

Example 30 is a non-transitory computer-readable medium comprising instructions, that when execute by at least one processor, causes the at least one processor to: receive a location request for a device within an indoor environment; receive respective light source identifiers associated with one or more light sources in the indoor environment, the one or more light sources in communication with the device; access a virtual map associated with the indoor environment, the virtual map including one or more associations between the respective light source identifiers and respective positions, within the indoor environment, of the one or more light sources; and determine, based at least in part on the virtual map and respective light source identifiers, a device location of the device within the indoor environment.

In Example 31, the subject matter of Example 30 can optionally include instructions that cause the at least one processor to interpolate respective positions of the one or more light sources with respect to the device.

In Example 32, the subject matter of Example 30 can optionally include that the light source comprises at least one of a light bulb or a light bulb socket.

In Example 33, the subject matter of Example 30 or 32 can optionally include instructions that cause the at least one processor to determine, based on the device location, the device is not within a location boundary; and generate a notification indicating the device is not within the location boundary.

What is claimed is:

1. A method, comprising:
receiving, by a computer comprising one or more processors, a location request for a device within an indoor environment;
receiving respective light source identifiers associated with one or more light sources in the indoor environment, the one or more light sources in communication with the device;
accessing, by the computer, a virtual map associated with the indoor environment, the virtual map comprising one or more associations between the respective light source identifiers and respective positions, within the indoor environment, of the one or more light sources; and
determining, based at least in part on the virtual map and the respective light source identifiers, a location of the device within the indoor environment.

2. The method of claim 1, wherein the at least one of the one or more light sources comprises a nearest light source to the device.

3. The method of claim 1, wherein determining the device location further comprises interpolating respective positions of the one or more light sources with respect to the device.

4. The method of claim 1, wherein the light source comprises at least one of a light bulb or a light bulb socket.

5. The method of claim 1, further comprising transmitting the virtual map to the one or more light sources.

6. The method of claim 5, further comprising updating the virtual map in response to a failure associated with at least one of the one or more light sources.

7. The method of claim 1, further comprising:
determining, based on the device location, that the device is not within a location boundary; and
generating, by the computer, a notification indicating that the device is not within the location boundary.

8. The method of claim 7, further comprising transmitting, by the computer, a signal to shut down the device.

9. The method of claim 1, further comprising transmitting the location to the device.

10. A device, comprising:
at least one processor; and
at least one memory storing computer-executable instructions, that when executed by the at least one processor, causes the at least one processor to:
access a virtual map associated with an indoor environment, wherein the virtual map indicates respective positions of one or more light sources in the indoor environment according to respective light source identifiers associated with the one or more light sources;
receive at least one light source identifier associated with the one or more light sources; and
determine, based at least in part on the at least one light source identifier and the virtual map, a location of the device within the indoor environment.

11. The device of claim 10, wherein the one or more light sources comprise one or more light bulbs or one or more light bulb sockets.

12. The device of claim 10, wherein the at least one light source identifier is associated with a respective light source, of the one or more light sources, that is nearest to the device.

13. The device of claim 10, wherein:
the at least one light source identifier comprises a plurality of light source identifiers associated with respective light sources, and
the location of the device is determined based at least in part on the virtual map, the plurality of light source identifiers, and an interpolation of respective positions of the respective light sources according to the virtual map and the plurality of light source identifiers.

14. The device of claim 10, wherein the computer-executable instructions further cause the at least one processor to:
determine, based on the virtual map and the at least one light source identifier, a failed light source of the one or more light sources.

15. The device of claim 14, wherein the computer-executable instructions further cause the at least one processor to:
generate an update to the virtual map to account for the failed light source.

16. The device of claim 10, further comprising an antenna in communication with the at least one processor and the at least one memory, the antenna configured to receive or transmit data.

17. The device of claim 10, wherein the computer-executable instructions further cause the at least one processor to:
display the location of the device within the indoor environment.

18. An apparatus, comprising:
a light source for generating light;
a receiver, coupled to the light source, to receive a device identification associated with a device in an indoor environment and access a virtual map associated with an indoor environment;
a location determination module to determine, based at least in part on the device identification and the virtual map, a location of the device within the indoor environment; and
a transmitter to transmit the location of the device to a server or to the device.

19. The apparatus of claim 18, wherein the light source comprises at least one of a light bulb or a light bulb socket.

20. The apparatus of claim 18, further comprising transmitting, by the transmitter, a location of the light source to the location determination module.

21. The apparatus of claim 18, further comprising transmitting, by the transmitter a light source identification to the location determination module.

22. A non-transitory computer-readable medium comprising instructions, that when executed by at least one processor, cause the at least one processor to:
receive a location request for a device within an indoor environment;
receive respective light source identifiers associated with one or more light sources in the indoor environment, the one or more light sources in communication with the device;
access a virtual map associated with the indoor environment, the virtual map including one or more associations between the respective light source identifiers and respective positions, within the indoor environment, of the one or more light sources; and
determine, based at least in part on the virtual map and respective light source identifiers, a device location of the device within the indoor environment.

23. The computer-readable medium of claim 22, wherein the at least one of the one or more light sources comprises a nearest light source to the device.

24. The computer-readable medium of claim 22, wherein the instructions further cause the at least one processor to:
determine the device location by interpolating the respective positions of the one or more light sources with respect to the device.

25. The computer-readable medium of claim 22, wherein the instructions further cause the at least one processor to:
transmit the virtual map to the one or more light sources.

26. The computer-readable medium of claim 25, wherein the instructions further cause the at least one processor to:
update the virtual map in response to a failure associated with at least one of the one or more light sources.

27. The computer-readable medium of claim 22, wherein the instructions further cause the at least one processor to:
determine, based on the device location, that the device is not within a location boundary; and
generate, by the computer, a notification that indicating the device is not within the location boundary.
